(19) United States
(12) Patent Application Publication
(10) Pub. No.: US 2026/0063362 A1
(43) Pub. Date: Mar. 5, 2026

(54) HEATED DAMMING SYSTEM AND METHOD FOR OPERATION OF THE HEATED DAMMING SYSTEM

(71) Applicant: Con-Vey, LLC, Roseburg, OR (US)

(72) Inventors: Dana Lee Jacobsen, Roseburg, OR (US); Spencer Reed Heard, Roseburg, OR (US)

(21) Appl. No.: 19/181,233

(22) Filed: Apr. 16, 2025

Related U.S. Application Data
(60) Provisional application No. 63/638,374, filed on Apr. 24, 2024.

(51) Int. Cl. F26B 3/347; H05B 6/78

(52) U.S. Cl. CPC F26B 3/347; H05B 6/78; F26B 2210/16

(57) ABSTRACT

Methods and systems for heating and damming a wood-based panel product. The heated damming system, in one example, includes a product movement device configured to advance a wood-based panel product in a longitudinal direction. The heated damming system further includes a heated damming assembly positioned on a lateral of the product movement device, where the heated damming assembly includes a heated belt that is rotated by a drive pulley and heated by a heating device.

### CROSS-REFERENCE TO RELATED APPLICATION

The present application claims priority to U.S. Provisional Application No. 63/638,374, entitled “HEATED DAMMING SYSTEM AND METHOD FOR OPERATION OF THE HEATED DAMMING SYSTEM”, and filed on Apr. 24, 2024. The entire contents of the above-listed application are hereby incorporated by reference for all purposes.

### FIELD

The present description relates generally to a heated damming system that heats and dams filled defects in a wood-based panel product.

### BACKGROUND/SUMMARY

Wood-based panel products such as plywood panels may have defects. To increase the quality of the wood-based panel products, the defects are repaired. These defects may include cracks, knots, discolorations, and the like. Attempts have been made to develop systems which repair defects in plywood panels and other wood-based panel products.

The inventors have recognized several drawbacks with conventional systems for repairing wood-based products. For instance, previous plywood repair systems have exhibited issues in relation to the repair of defects on lateral sides of the panels. For instance, when the defects are on the sides of the panels, the filler may leak from the defect, particularly when the defect is routed out. Attempts have been made to implement a manual process for repairing side defects, which involves a lengthy cure time and the use of tape and/or other consumables to reduce the chance of the filler leaking from the defect.

To overcome at least a portion of the aforementioned challenges, the inventors developed a heated damming system. The heated damming system, in one example, includes a product movement device (e.g., conveyor) that advances a wood-based panel product in a longitudinal direction. The heated damming system further includes a heated damming assembly that is positioned on a lateral side of the product movement device. In the heated damming system, the heated damming assembly includes a heated belt (e.g., a metal belt) that is rotated by a drive pulley and heated by a heating device (e.g., a series of heating devices). The heated damming assembly allows a filler (e.g., a polymer, a resin, and/or a putty) that has been applied to panel defects that have been routed or otherwise machined to be retained therein with a reduced chance of leakage while simultaneously heating the filler material. Consequently, the system is able to efficiently and effectively repair defects in the wood product by simultaneously containing and curing the filler. To elaborate, the system is able to be continuously run in an automated manner without the use of consumables such as tape, if desired.

In one example, the heating device may be an induction coil and the heated damming assembly may include multiple rollers which guide the heated belt along the side of the wood-based panel product. In this way, the heated damming system is capable of efficiently heating the belt and moving it along the lateral side of the wood-based panel product.

Further, in one example, the heated damming assembly includes one or more actuators that are configured to adjust a lateral position of the heated damming assembly. In this way, the system's adaptability is increased, enabling the system to process wood-based panel products with a variety of different lateral widths.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a perspective view of a heated damming system.

FIG. 2 shows a top view of the heated damming system, depicted in FIG. 1.

FIG. 3 shows a detailed perspective view of one of the heated damming assemblies in the heated damming system, depicted in FIG. 1.

FIG. 4 shows a top view of one of the heated damming assemblies in the heated damming system, depicted in FIG. 1.

FIG. 5 shows a side view of one of the heated damming assemblies in the heated damming system, depicted in FIG. 1.

FIG. 6 shows a detailed view of a portion of the heated damming assembly.

### DETAILED DESCRIPTION

The following description relates to a heated damming system that efficiently repairs wood-based panel products by containing and curing filler that has been applied to routed defects in the product through the use of a belt which is heated to rapidly cure the filler. The heated damming system includes a conveyor or other suitable product movement device and a heated damming assembly which includes the belt. The heated damming device further includes a drive pulley which rotates the heated belt. Heated damming assemblies may be positioned on opposing lateral sides of the wood-based panel product to enable defects on both edges of the panel to be rapidly repaired. To elaborate, the damming assemblies include heated belts that move along the sides of the wood-based panel product to simultaneously heat the filler and reduce the chance of the filler leaking from the defect, prior to curing of the filler. In this way, the system efficiently and automatically repairs the wood-based panel product.

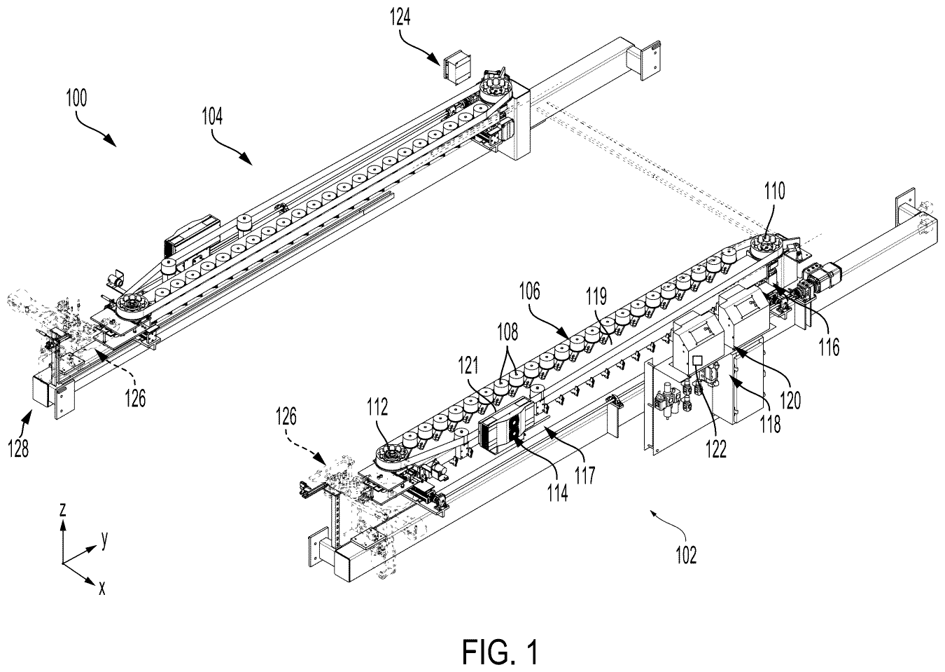

FIG. 1 shows an example of a heated damming system 100 for repairing wood-based panel products. The types of wood-based panel products which may be used in the system include, but are not limited to, products such as plywood, particle board, fiber board, oriented strand board, and the like. As such, the wood-based panel products may contain wood in the form of chips, veneers, strips, strands, fibers, combinations thereof, and the like. Additionally, the wood-based products may contain adhesives such as urea formaldehyde (UF) glue, phenol formaldehyde (PF) glue, melamine urea formaldehyde (MUF) glue, epoxy glue, combinations thereof, and the like. To elaborate, the wood-based products may include multiple layers of wood bonded together with one or more adhesive(s).

The wood-based products may have a variety of dimensions but generally have substantially planar top and bottom surfaces. Further, as discussed in greater detail herein, the wood-based products may have defects that have been routed out (and/or otherwise machined) and then filled with a filler material. Additionally, the wood-based products may have a variety of lengths. As discussed in greater detail herein, the heated damming system 100 is designed to repair wood-based panel products of varying widths.

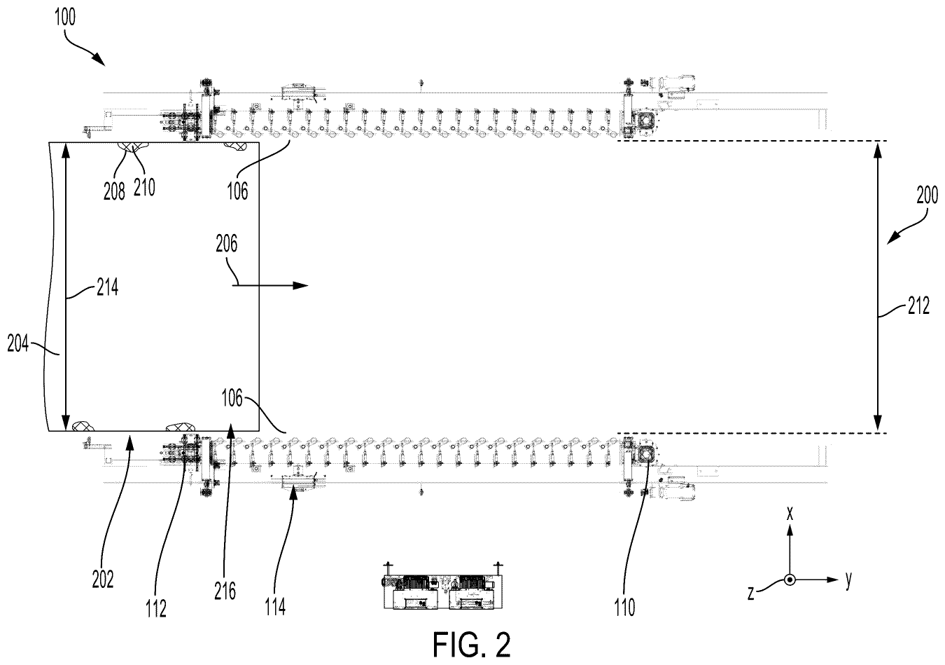

In the illustrated example, the heated damming system 100 includes heated damming assemblies 102 and 104 positioned on opposing lateral sides of a product movement device 200 (e.g., a conveyor) shown in FIG. 2 and discussed in greater detail herein.

As illustrated in FIG. 1, the heated damming assemblies 102 and 104 include similar components in a mirrored configuration, in the illustrated embodiment. Therefore, redundant description of the components is omitted for brevity. However, it will be appreciated that one control system (discussed in greater detail herein) may be provided for both heated damming assemblies, in one example. The heated damming assembly 102 includes a heated belt 106, rollers 108, a drive pulley 110 (e.g., a head pulley), and an idler pulley 112 (e.g., a tail pulley), in the illustrated example. However, other system configurations are possible. Rotational axes of the idler and drive pulleys may be vertically aligned. Further, the rotational axes of the rollers 108 may be aligned along a longitudinal axis to enable the heated belt 106 to form a planar surface that functions as a dam that laterally abuts a wood-based panel product to reduce the chance of liquid filler (that has been applied to defects in the panel product) leaking out of the defect, as discussed in greater detail herein.

The heated damming assembly 102 further includes a heating device 114. Specifically, in one example, the heating device 114 may be included in a series of heating devices. The heating device 114 is specifically an induction coil assembly in the illustrated example. However, other suitable types of heating devices may be used in other examples such as a gas heater. When the assembly includes a series of heating devices, multiple induction coils may be used in the assembly or a combination of different types of heating devices may be used in the assembly. In the illustrated example, the heating device 114 includes an inboard face 121 which may contact and heat the belt 106 as it rotates. However, the heating device may have other suitable configurations, in alternate examples.

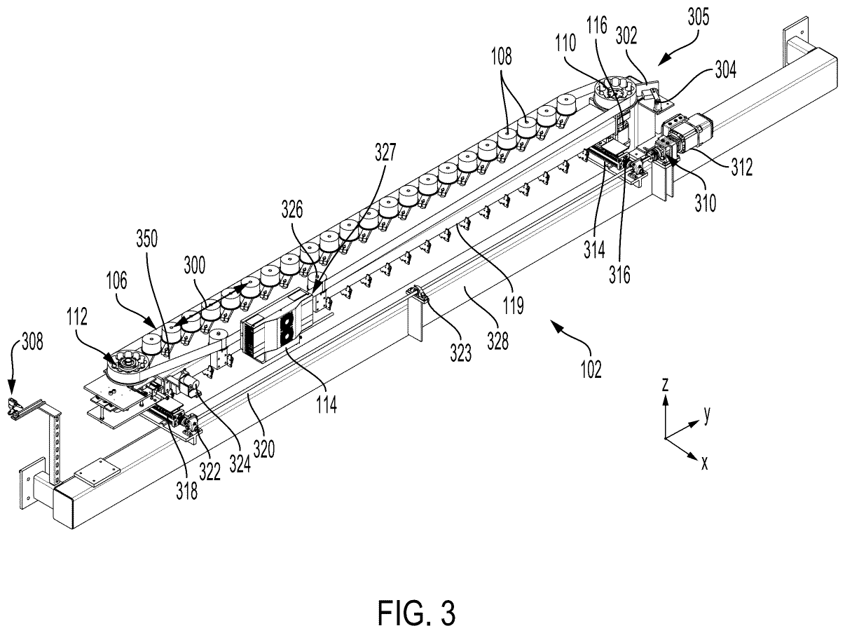

The drive pulley 110 may be driven by a gear motor 116, which is discussed in greater detail herein with regard to FIG. 3. Rotation of the drive pulley 110 rotates the belt 106 such that is travels along the side of a wood-based panel product, discussed in greater detail herein with regard to FIG. 2, and through or alongside the heating device 114. The heating device 114 is positioned on an outer side 117 of the assembly. However, other heating device positions have been contemplated. The heating device 114, the drive pulley 110, the idler pulley 112, and the rollers 108 are mounted on a dam beam 119, in the illustrated example. However, other suitable support structures may be used for mounting the rollers, the heating device, and/or the pulleys. In the illustrated example, the rollers 108 are positioned longitudinally between the drive pulley 110 and the idler pulley 112.

The heated damming system 100 further includes a control assembly 118 with control panels 120, in the illustrated example. The control panels may include one or more controllers 122 which include circuitry such as one or more processor(s) and memory that stores instructions which are executable by the processor(s). As such, the control techniques described herein may be stored as instructions in the controller's memory. The control panels 120 are electronically coupled to components in the heated damming assemblies 102 and 104 to control operation thereof. For instance, motors, heat devices, and the like, discussed in greater detail herein, may be in electronic communication with the controllers 122 in the control panels.

The heated damming system 100 may further include a junction box 124 which may function as an electrical interface for the system. The heated damming system 100 may further include taping machines 126 that are positioned at the front side 128 of each of the heated damming assemblies 102 and 104. However, the taping machines may be omitted from the system in other examples.

An axis system is provided in FIG. 1, as well as FIGS. 2-6 for reference. The z-axis may be a vertical axis (e.g., parallel to a gravitational axis), the x-axis may be a lateral axis (e.g., horizontal axis), and the y-axis may be a longitudinal axis, in one example. However, in other examples, the axes may have other orientations.

FIG. 2 shows a top view of the heated damming system 100 which includes the heated damming assemblies 102 and 104 and the product movement device 200 which is in the form of a conveyor (e.g., a belt conveyor) in the illustrated example. In the illustrated example, the conveyor 200 includes a vacuum beltway 202 which directs a wood-based panel product 204 therethrough. However, other suitable types of product movement devices may be used in the system, in other examples. Arrow 206 denotes the longitudinal direction of wood-based panel product 204 movement through the heated damming system 100.

The wood-based panel product 204 includes defects 208 that have been routed out (and/or otherwise machined) and then filled with filler 210. In one example, the filler 210 may be manually applied via personnel. However, in other examples, the heated damming system 100 or another suitable system may be designed to apply the filler 210 into the defects 208. Further, it will be understood that the defects 208 may be routed or otherwise machined prior to the application of the filler 210. The defect routing may be automatically implemented using another suitable system or may be manually carried out via personnel. The filler 210 may include a putty, a polymer such as polyethylene, a resin, combinations thereof, and the like. More generally, the filler 210 may include a substance that is configured to be heat cured.

A lateral width 212 between the belts 106 in the heated damming assemblies 102 and 104 is depicted in FIG. 2. The lateral width 212 corresponds to the width 214 of the wood-based panel product. It will be understood that the heated damming assemblies 102 and 104 may be configured to adjust the width 212. This width adjustment functionality is expanded upon herein with regard to FIGS. 3-6.

Rotation of the drive pulley 110 moves the belt 106 along an edge 216 of the wood-based panel product 204 and then through the heating device 114, in the illustrated example. In this way, the belt is able to simultaneously contain and cure the filler which has been applied to the routed defects, thereby increasing the efficiency of the repair process when compared to previous repair processes which use tape and/or other disposables to contain the filler. FIG. 2 further shows the drive pulley 110 and the idler pulley 112 positioned laterally outboard of the rollers 108. However, in other examples, the drive pulley and/or the idler pulley 112 may be positioned in a similar laterally positioned with regard to the rollers 108.

FIG. 3 shows a detailed view of the heated damming assembly 102. The heated damming assembly 102 includes the drive pulley 110, the idler pulley 112, the rollers 108 (e.g., pressure rollers), the heated belt 106, and the heating device 114, as indicated above. The control system has been omitted from the heated damming assembly 102 to reveal underlying components. However, it will be appreciated that the control system may be incorporated into the heated damming assembly, in practice.

At least a portion of the rollers 108 may be arranged along a longitudinal axis 300 to enable the heated belt 106 to have a planar contour in the area adjacent to the lateral sides of the wood-based panel product. Further, the rollers 108 are positioned between the drive pulley 110 and the idler pulley 112 with regard to the longitudinal direction. However, other roller arrangements are possible. Rotational axes of the rollers 108 may be vertically aligned.

The heated damming assembly 102 may include a belt scraper 302 and a tensioner 304. The belt scraper 302 functions to remove filler from the belt and the tensioner applies a desired tension to the belt to reduce undesirable belt deflection. The belt scraper 302 and/or tensioner 304 are positioned on a longitudinally outboard side 305 of the drive pulley 110, in the illustrated example. However, in other examples, the belt scraper and/or the tensioner may be omitted from the assembly.

The heated damming assembly 102 may further include the dam beam 119 that provides structural support to the assembly. The dam beam 119 may specifically be longitudinally aligned. The dam beam may be constructed out of one or more suitable materials such as steel, aluminum, polymeric materials, and the like. The heated damming assembly 102 may further include a laser 308 that may be used for panel alignment.

The heated damming assembly 102 may further include the gear motor 116 which is rotationally coupled to (e.g., directly rotationally coupled to) the drive pulley 110. The gear motor 116 therefore induces movement of the belt 106. The gear motor 116 and the other motors described herein may be supplied with electrical power from a power source via a wired connection. The gear motor may include an electric motor, a hydraulic motor, and/or a servo motor. Further, in one example, a non-stick coating 350 may be applied to the heated belt 106. The non-stick coating 350 may include polytetrafluoroethylene (PTFE), in one specific case. However, a variety of suitable non-stick coating have been contemplated.

The heated damming assembly 102 may further include a width adjustment device 310 that is configured to adjust the lateral position of the heated damming assembly 102 to allow the assembly to be adjusted to accommodate for wood-based panel products of differing widths. The width adjustment device 310 may include a gear motor 312 which may be coupled to an actuator 314 via a gearbox 316 (e.g., a right angle gearbox) that is configured to provide speed/torque conversion functionality.

The gear motor 312 may be rotationally coupled to another actuator 318 via an adjustment shaft 320 and a gearbox 322. However, other layouts of the width adjustment device 310 may be used. Further, the gear motor 312 may be positioned vertically below the drive pulley 110 to increase the compactness of the assembly. A bearing 323 may be coupled to the adjustment shaft 320 to reduce the chance of undesirable shaft flexion. The bearing 323 is coupled to the support frame 328, in the illustrated example.

A pyrometer 324 and/or other suitable temperature sensor may further be included in the heated damming assembly 102. The pyrometer 324 may send signals indicative of the temperature of the heated belt 106 to the control system. To elaborate, the temperature of the belt may be adjusted using feedback control. For instance, the control system may be used to establish a desired temperature set-point or an operating temperature range. After the set-point is determined, the belt may be heated to maintain the heated belt 106 around the set-point using a feedback control loop. However, more advanced control techniques have been contemplated. More generally, the heating device 114 and/or the gear motor 116 may be controlled based on the signals from the pyrometer.

The drive pulley 110, the idler pulley 112, and the rollers 108 are configured to rotate the heated belt 106 along the side of the wood-based panel product and guide the belt next to or through the heating device 114 (e.g., induction coil assembly) to allow the belt to be continuously rotated around a loop which guides the belt next to the wood-based panel product and the heating device. In this way, filler applied to the wood-based panel product is able to be effectively dammed and heated to facilitate efficient curing. The heated belt may be constructed out of metal such as stainless steel. Pressure rollers 326 may be included in the set of rollers 108. The pressure rollers allow the belt 106 to travel along the heating device 114 in a desired manner such that heat is efficiently transferred to the belt. The pressure rollers 326 may be positioned adjacent to sides 327 of the heating device 114. The pressure rollers 326 allow the belt 106 to be tensioned by a desired amount and enable the belt to effectively interact with the heating device 114 to enable efficient heat transfer therebetween.

A support frame 328 may additionally be provided in the heated damming assembly 102. The support frame 328 provides support to the width adjustment device 310 and the gear motor 116, in the illustrated example. However, other suitable support structures for the assembly have been contemplated.

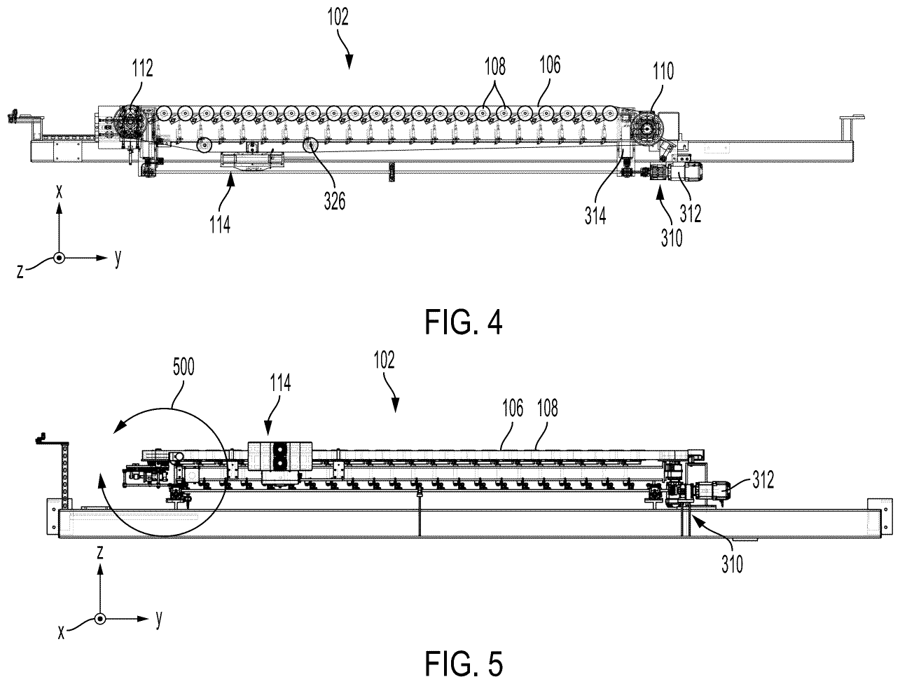

FIG. 4 shows a top view of the heated damming assembly 102. The rollers 108 are again depicted along with the belt 106, the drive pulley 110, the idler pulley 112, and the heating device 114. The width adjustment device 310 which includes the gear motor 312 and the actuators 314 and 318 are again depicted. The pressure rollers 326 are again depicted in FIG. 4.

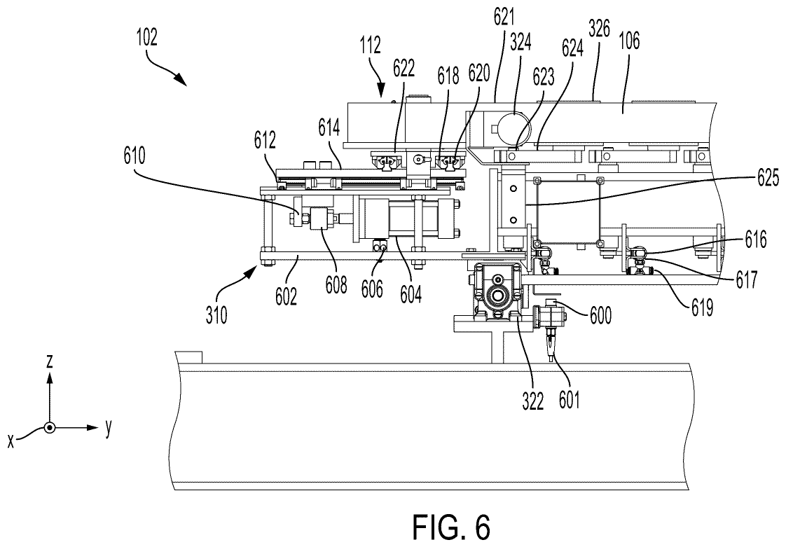

FIG. 5 shows a side view of the heated damming assembly 102. The belt 106, the rollers 108, and the heating device 114 are again illustrated. The width adjustment device 310 which includes the gear motor 312 and the actuators 314 and 318 are again depicted. Section 500 indicates the location of the detailed view of a portion of the heated damming assembly, depicted in FIG. 6.

FIG. 6 shows a detailed view of a portion of the heated damming assembly 102 and specifically the width adjustment device 310. The belt 106, the pressure rollers 326, the idler pulley 112 (e.g., the tail pulley), the gearbox 322, and the pyrometer 324 are depicted in FIG. 6. A proximity switch 600 which may be electrically coupled to the control system via an electrical interface 601 is further shown in FIG. 6. The proximity switch 600 may specifically validates that the width adjustment device is in the proper position required to operate the heated damming system.

The width adjustment device 310 may include a beam 602 which may be coupled to the gearbox 322. An air cylinder 604 may further be included in the width adjustment device 310 and a muffler flow control device 606 may be coupled to the air cylinder in order to maintain proper tension on the metal damming belt. A rod end coupler 608 and a rod end anchor 610 may provide attachment between a take-up plate 612 which may be coupled to a rail plate 614. An air cylinder 616, a pivot bracket assembly 617, a push lock swivel branch 619, a mounting bracket 621, a pivot shaft 623, and a device bracket 625 may further be included in the width adjustment device. A runner block 618, a linear rail 620, a take-up carriage 622, and a pressure arm 624 are further depicted in FIG. 6 in order to allow for constant belt contact between varying lengths of wood-based panel products.

FIGS. 1-6 provide for a method for operating a heated damming system. The method may be carried out by any of the heated damming systems discussed herein or combinations of the heated damming systems. Further, at least a portion of the method steps may be implemented as instructions stored in memory that are executable by a processor. However, it will be understood that some of the steps may be manually implemented by factory personnel such as the step of applying filler to a wood-based panel product. The method includes routing out defects in the wood-based panel product. Next, the method includes applying filler to the routed defects. As previously indicated, the steps of routing the defects and applying the filler may be manually implemented by personnel, in one example. In other examples, the steps of routing the defects and/or applying the filler may be automatically implemented using a system which includes a router and a filler application device. The method additionally includes heating and rotating a belt in a heated damming assembly that is positioned on a lateral side of a product movement device. It will be appreciated that the step of heating and rotating the belt may be implemented in two assemblies that are positioned on opposing lateral sides of the wood-based panel product. In this way, the filler is simultaneously contained within the routed defect and cured. Consequently, the wood-based panel product is able to be efficiently repaired.

FIGS. 1-6 show example configurations with relative positioning of the various components. If elements in FIGS. 1-6 are shown directly contacting each other, or directly coupled, then such elements may be referred to as such. Similarly, elements shown contiguous or adjacent to one another may be contiguous or adjacent to each other, in an example. Components that lay in face-sharing contact with one another may be referred to as such in one example. Components positioned away from each other no components therebetween may be referred to as such. As yet another example, elements shown above or below one another, at opposite sides to one another, or to the left or right of each other may be referred to in such a manner. Further, a topmost component may be referred to as a “top” of the feature and a bottommost component may be referred to as a “bottom” of the feature, in at least one example. As used herein, top and bottom, upper and lower, above and below, may be relative to a vertical axis of the figures and used to describe positioning of components in the figures. As yet another example, shapes of the figure elements may be referred to as having those specific shapes. These shape descriptors include circular, straight, planar, curved, rounded, chamfered, angled, or the like. Further, elements that are depicted intersecting one another may be referred to as such in one example. Further still, an element shown within another element or shown outside of another element may be referred in this manner, for example.

The invention will be further discussed in the following paragraphs. In one example, a heated damming system is provided that includes a product movement device configured to advance a wood-based panel product in a longitudinal direction; and a heated damming assembly positioned on a lateral of the product movement device; wherein the heated damming assembly includes a heated belt that is rotated by a drive pulley and heated by a heating device. In one example, the heating device may be an induction coil. In another example, the heated damming assembly may include a plurality of rollers that guide the heated belt. In yet another example, the plurality of rollers may be arranged along an axis that is parallel along a longitudinal axis. In yet another example, the heated damming assembly may include a width adjustment device that is configured to adjust a lateral position of the heated damming assembly. In another example, the drive pulley may be driven via an electric motor. In another example, the wood-based panel product may be a wood product with a filler material positioned in one or more routed defects. In another example, the filler may include a polymer, a resin, and/or a putty. In yet another example, the product movement device may be a conveyor. In another example, the belt may be a metal belt.

In another aspect, a method for operation of a heated damming system is provided that comprises heating and rotating a belt in a heated damming assembly that is positioned on a lateral side of a product movement device; wherein the heated damming system includes: the product movement device configured to advance a wood-based panel product in a longitudinal direction; and the heated damming assembly positioned on a lateral side of the product movement device. In one example, the method may further comprise moving a wood-based panel product through the product movement device. In another example, the product movement device may be a conveyor belt. In yet another example, the belt may be heated via an induction coil assembly and is constructed out of metal. In another example, the belt may be rotated via an electric motor.

In another aspect, a heated damming system is provided that comprises a conveyor configured to advance a wood-based panel product in a longitudinal direction; and a pair of heated damming assemblies positioned on opposing lateral sides of the conveyor; wherein the pair of heated damming assemblies each include a heated metal belt that is rotated by a drive pulley and heated by a heating device. In another example, in the heated damming system, the pair of heated damming assemblies may each include a plurality of rollers that guide the heated belt; and the drive pulley may be driven via an electric motor. In another example, the pair of heated damming assemblies each may include a width adjustment device that is configured to adjust a lateral position of the heated damming assembly. In another example, the wood-based panel product may include a plurality of routed defects that are filled with a filler that includes a polymer, a resin, and/or a putty. In another example, the heated metal belt may be constructed out of stainless steel.

Note that the system control methods discussed herein can be used with various heated damming system configurations. Further, the sequence of the method steps is not necessarily demanded to achieve the features and advantages of the example embodiments described herein, but is provided for ease of illustration and description. One or more of the illustrated method steps, operations, and/or functions may be repeatedly performed depending on the particular strategy being used.

It will be appreciated that the configurations and routines disclosed herein are exemplary in nature, and that these specific embodiments are not to be considered in a limiting sense, because a multitude of variations are possible.

FIGS. 1-6 are shown approximately to scale aside from the schematically depicted components. However, the components may have alternate relative dimensions, in other embodiments.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed functions, components, elements, and/or properties may be claimed through amendment of the present claims or through presentation of new claims in this or a related application. Such claims, whether equal, narrower, broader, or different in scope to the original claims, also are regarded as included within the subject matter of the present disclosure.

1. A heated damming system, comprising:
a product movement device configured to advance a wood-based panel product in a longitudinal direction; and
a heated damming assembly positioned on a lateral of the product movement device;
wherein the heated damming assembly includes a heated belt that is rotated by a drive pulley and heated by a heating device.

2. The heated damming system of claim 1, wherein the heating device is an induction coil.

3. The heated damming system of claim 1, wherein the heated damming assembly includes a plurality of rollers that guide the heated belt.

4. The heated damming system of claim 3, wherein the plurality of rollers are arranged along an axis that is parallel along a longitudinal axis.

5. The heated damming system of claim 1, wherein the heated damming assembly includes a width adjustment device that is configured to adjust a lateral position of the heated damming assembly.

6. The heated damming system of claim 1, wherein the drive pulley is driven via an electric motor.

7. The heated damming system of claim 1, wherein the wood-based panel product includes a filler positioned in one or more routed defects.

8. The heated damming system of claim 7, wherein the filler includes a polymer, a resin, and/or a putty.

9. The heated damming system of claim 1, wherein the product movement device is a conveyor.

10. The heated damming system of claim 1, wherein the heated belt is a metal belt.

11. A method for operation of a heated damming system, comprising:
heating and rotating a belt in a heated damming assembly that is positioned on a lateral side of a product movement device;
wherein the heated damming system includes:
the product movement device configured to advance a wood-based panel product in a longitudinal direction; and
the heated damming assembly positioned on a lateral side of the product movement device.

12. The method of claim 11, further comprising moving a wood-based panel product through the product movement device.

13. The method of claim 12, wherein the product movement device is a conveyor belt.

14. The method of claim 11, wherein the belt is heated via an induction coil assembly and is constructed out of metal.

15. The method of claim 14, wherein the belt is rotated via an electric motor, a servo motor, and/or an electric motor.

16. A heated damming system, comprising:
a conveyor configured to advance a wood-based panel product in a longitudinal direction; and
a pair of heated damming assemblies positioned on opposing lateral sides of the conveyor;
wherein the pair of heated damming assemblies each include a heated metal belt that is rotated by a drive pulley and heated by a heating device.

17. The heated damming system of claim 16, wherein:
the pair of heated damming assemblies each include a plurality of rollers that guide the heated metal belt; and
the drive pulley is driven via an electric motor.

18. The heated damming system of claim 17, wherein the pair of heated damming assemblies each include a width adjustment device that is configured to adjust a lateral position of the pair of heated damming assemblies.

19. The heated damming system of claim 16, wherein the wood-based panel product includes a plurality of routed defects that are filled with a filler that includes a polymer, a resin, and/or a putty.

20. The heated damming system of claim 16, wherein the heated metal belt is constructed out of stainless steel and has a non-stick coating applied thereto.
